(19) United States
(12) Patent Application Publication
(10) Pub. No.: US 2007/0151447 A1
(43) Pub. Date: Jul. 5, 2007

(54) Gas separation membranes and processes for controlled environmental management

(75) Inventor: Timothy Charles Merkel, Menlo Park, CA (US)

Correspondence Address: MEMBRANE TECHNOLOGY AND RESEARCH INC., 1360 WILLOW ROAD SUITE 103, MENLO PARK, CA, 94025-1516, US

(73) Assignee: Membrane Technology and Research, Inc., Menlo Park, CA (US)

(21) Appl. No.: 11/644,727

(22) Filed: Dec. 22, 2006

Related U.S. Application Data
(60) Provisional application No. 60/755,380, filed on Dec. 30, 2005.

(51) Int. Cl. B01D 53/22

(52) U.S. Cl. 95/52

(57) ABSTRACT

A gas-separation membrane, membrane module and membrane process for controlling humidity in an environment. The membrane has a porous support zone impregnated by a selective zone, a configuration that reduces concentration polarization within the membrane itself when the membrane is housed in the module and used in the process.

This application claims the benefit of U.S. Provisional Application Ser. No. 60/755,380, filed Dec. 30, 2005 and incorporated herein by reference.

### FIELD OF THE INVENTION

The invention relates to gas separation membranes, and specifically to the use of gas separation membranes to maintain a controlled environment.

### BACKGROUND OF THE INVENTION

Gas separation membranes have been in industrial use for close to 25 years. Various types of membrane are available, although almost all commercially successful membranes are polymeric membranes formed as flat sheets or hollow fibers. Such polymeric membranes typically have a composite structure, comprising a relatively unselective microporous support membrane, which provides mechanical strength, coated with at least one thin selective layer of another material, which is primarily responsible for the separation properties.

The membrane may take the form of an integral asymmetric membrane, in which the support and the selective layer are formed from the same material by a technique that produces a membrane of graded porosity across its thickness. Alternatively, the membrane may be a composite structure, in which the microporous support layer is formed first, then coated with the selective layer as a separate operation. In either case, the support layer is microporous and the membrane is typically reinforced by casting it on a fabric or paper web, made of polyester, for example. Commonly, other layers, including gutter layers and sealing layers, are also included, so that overall the membrane may have three, four or more layers.

Diverse polymers can be used to make gas separation membranes, and different materials are suited to different separations. For example, membranes made from cellulose acetate have been used for many years to remove or recover carbon dioxide, such as in natural gas processing; polyimide membranes are particularly useful for hydrogen separation, such as in refinery applications; and silicone rubber membranes are the membranes of choice for separating organic vapors from nitrogen.

Many polymers, including those that are nominally hydrophobic, are very permeable to water vapor, and a variety of materials have been used to make membranes intended for certain dehydration or humidification uses. For example, membranes can be made with extremely high water permeability using polar materials, and particularly ion-exchange polymers, as the water-selective material. Such membranes are taught in U.S. Pat. Nos. 5,547,551; 5,599,614; 6,130,175 and 6,254,978, all assigned to W. L. Gore, for example. U.S. Pat. No. 6,841,601, to Serpico et al., describes a sulfonated membrane of a particular construction, and a cell containing the membrane, for transferring heat, ions or moisture under unspecified circumstances.

Ion-exchange membranes, made from Nafion® or the like, are used in electrochemical devices, such as electrolysers, electrodialysis stacks and as the polymer electrolyte layer for proton exchange membrane (PEM) fuel cells. Despite their high permeability, these membranes are not well suited for use as gas separation membranes for water vapor transport. They are complicated to manufacture, expensive, and their performance is sensitive to the water content of the feed gas mixture, with permeability changing over several orders of magnitude in response to changes in relative humidity (RH). In addition, they are not physically robust, and when dry become brittle and liable to crack.

Other hydrophilic materials from which water-separating membranes can be made include charge neutral polymers, such as polyurethanes, as in U.S. Pat. No. 5,209,850, to Abayasekara et al; polyethers of various types, as in U.S. Pat. No. 4,969,998, to Henn, and U.S. Pat. No. 4,963,165, to Blume et al; polyvinyl alcohol and chitosan.

If suitable selective polymers are chosen, gas separation membranes can provide good performance in separating oxygen from nitrogen, carbon dioxide from methane, small organic molecules from nitrogen, and many other separations. Gas separation membranes are much less successful at separating water vapor from other gases, however. When used to permeate water vapor, many membranes under many operating conditions can only achieve a water vapor flux or permeance that is much lower than predicted based on the permeability of the polymer.

This problem occurs in part as a result of the exceptionally high intrinsic permeability of many polymers to water. As water is transported from the feed stream to the permeate side of the membrane, a boundary layer of water-depleted gas is formed adjacent to the feed side of the membrane. This boundary layer acts as an additional resistance in series with the membrane, thereby reducing transmembrane flux.

Membrane processes may be pressure-driven or concentration-driven. Loss of performance owing to boundary layer effects is exacerbated in concentration-driven processes, where, compared with pressure-driven processes, gas may be relatively stagnant on the permeate as well as the feed side of the membrane.

Control of humidity is important in many fields, such as storage and transport of perishable items, including archive materials; manufacture of consumer goods, such as electronics or pharmaceuticals; specialized processes, such as operation of reactors or fuel cells; and maintenance of comfortable human environments.

As mentioned above, the use of membranes to dehydrate or humidify gas is known, and descriptions of many processes involving a membrane separation step can be found in the literature. For example, U.S. Pat. No. 6,106,964, to Voss et al., describes the use of a membrane to remove excess water vapor from a wet stream exiting a fuel cell and transport the water to a dry stream entering the fuel cell. A similar process is described in U.S. Pat. No. 6,656,620, to Katagiri et al.

As another example, U.S. Pat. No. 6,145,588, to Martin et al., discloses an air-to-air moisture exchanger for controlling the humidity of room air in conjunction with heating or air-conditioning.

U.S. Pat. No. 5,575,835, to Bailey et al., describes use of water-permeable membranes as part of a heat pump to control the humidity within a storage environment or the like.

U.S. Pat. No. 5,996,976, to Murphy et al., describes a system for humidifying reactant gases for various electrochemical devices.

For all of the reasons discussed above, better membranes and operating methods are needed to mitigate poor performance in water vapor separation applications.

### SUMMARY OF THE INVENTION

The invention is a membrane, membrane module and membrane process for controlling humidity in an environment, by creating a gas stream with a desired water-vapor content and passing that stream into the environment.

The gas stream of desired water-vapor content is created using a gas separation membrane. The membrane separates a feed gas stream having a higher or lower water content than is desired into a residue stream depleted in water vapor compared with the feed and a permeate stream enriched in water vapor compared with the feed. Either the residue stream or the permeate stream has the desired water vapor content and is passed into the environment.

As mentioned above, many polymeric materials are extremely permeable to water vapor, with permeabilities as high as 100,000 Barrer or more, much higher than their permeabilities to other gases, such as nitrogen, oxygen, methane and the like. Unfortunately, when such a polymer is used to make a water-selective membrane, however, this extremely high permeability often does not translate to correspondingly extremely high water flux across the membrane.

The membranes and processes of the invention ameliorate this problem by reducing resistance to water vapor transport inside the membrane itself. To understand this aspect of the invention, a simplified discussion of the source of this resistance follows.

In membrane separation processes, a fluid mixture contacts the feed side of the membrane, and a permeate enriched in one of the components of the mixture is withdrawn from the permeate side. Because the feed mixture components permeate at different rates, concentration gradients form in the fluids on both sides of the membrane. The fluid layer immediately adjacent to the membrane surface becomes depleted in the faster permeating component on the feed side of the membrane and enriched in this component on the permeate side. The phenomenon is called concentration polarization, and is one reason for the discrepancy between permeability and flux noted above.

A simple approach to understanding what happens on the feed side is to assume that the fluid velocity in the feed channel is not uniform. In the middle of the channel, fluid flow velocity is high, flow is turbulent, and the fluid is well mixed. The feed fluid velocity decreases as the distance from the membrane surface decreases; at the fluid-membrane surface, friction reduces the fluid velocity to essentially zero. The result is a component-depleted boundary layer next to the membrane in which flow is laminar, and mixing occurs only by diffusion.

The factors that determine the magnitude of concentration polarization include the thickness of the boundary layer, and how fast the component of interest can diffuse across the boundary layer.

By similar reasoning, concentration polarization effects can also occur at the permeate side interface of the membrane and the permeate fluid mixture, where a component-enriched boundary layer can build up.

The magnitude and importance of concentration polarization depend on the membrane separation process. In many membrane processes, there is a considerable bulk flow of liquid or gas through the membrane, and the permeate-side composition depends only on the ratio of the components permeating the membrane. When this is the case, concentration gradients only form on the feed side of the membrane.

Many gas separations are performed as pressure-driven processes, with a large pressure difference between the feed and permeate sides of the membrane. In this case, the situation described in the previous paragraph obtains, and concentration gradients only form on the feed side of the membrane. In addition, the diffusion coefficients of gases tend to be high, so even on the feed side, for most gas separations, the effect is typically not large enough to affect the overall performance of the process. Consequently, concentration polarization in gas separation processes has not been widely studied, and is often disregarded completely.

In the case of water vapor transport, however, the feed-to-permeate pressure differences tend to be much lower than they would be for other gas separations, and the water fluxes tend to be very high compared with the fluxes of other gases. As a result, concentration polarization on the feed side can be significant.

If the process is not pressure-driven, but concentration-driven, gases at both the feed side and permeate side membrane interfaces are relatively stagnant. In this case, by the same reasoning as explained above for the feed side, the water-vapor concentration at the gas/membrane interface on the permeate side may be high compared with the overall water-vapor content of the permeate stream, presenting another boundary layer that represents part of the overall resistance to good water vapor transport. In this case, concentration polarization on the permeate side reduces the driving force for water transport across the membrane, thereby further reducing water flux.

The concentration polarization problems already discussed refer to the properties of the gases adjacent to the membrane outside the membrane surface. Unexpectedly, we have found that yet a third factor needs to be considered when using gas separation membranes for water vapor separation—resistance within the membrane itself outside the selective layer.

As mentioned above, several structurally distinct layers are present in most gas separation membranes—the dense polymeric selective layer, the microporous polymeric support layer and a more openly porous fibrous backing layer, which is generally made of non-woven fabric or paper type material. In most membrane-based gas-separation processes, the dominant resistance to gas permeation is the selective layer; the microporous support region underlying the selective layer presents little or no resistance to gas permeation, and the backing material, being much more openly porous, consistent with ordinary paper or fabric, presents essentially no resistance to gas permeation. This is an intrinsic design feature of the membranes.

With a membrane of this type, we believe that a third source of concentration polarization inside the membrane creates a significant resistance, and, in fact, can be the dominant resistance, if the membrane is used to separate water vapor. We believe this effect is brought about by the presence of stagnant layers or areas of gas inside the membrane in the microporous support layer.

We believe these areas of internal stagnant gas become depleted in water vapor in a manner similar to the boundary layer effects described above and represent a bigger resistance to water vapor permeation than does the polymer of the selective layer. In other words, with respect to water vapor transport inside the membrane, in some circumstances a pocket of water-depleted gas may be less permeable to water vapor than a pocket of polymer. This is a surprising and unexpected phenomenon.

Several consequences flow from our discovery. First, an important factor in designing and manufacturing a gas separation membrane for water vapor transport is to overcome this effect by reducing microporous layers or pockets in which stagnant gas resists water transport.

This means that conventional manufacturing methods for gas separation membranes—to prepare an asymmetric membrane with a graded porosity, or to coat a non-porous selective layer on the skin layer of a microporous support—are not suitable for making water vapor transport membranes.

Instead, the membrane, through a percentage of its total volume, or optionally throughout essentially its total volume, should be devoid of microporous areas, because these are the areas in which gas can become stagnant under the operating conditions of water-vapor separation applications.

In principle, a membrane free of microporous areas could be made by simply forming a homogeneous film of the selective polymer. To have adequate mechanical strength, however, this film would have to be very thick, such as 100 μm, 200 μm or more thick, in which case the flux through the film would be undesirably low.

Various membrane configurations with low internal resistance achieved by a reduction or absence of microporous zones are possible within the scope of the invention. These include membranes in which no microporous structures are used in any layer, and membranes in which a layer or zone with a microporous structure is used, but wherein the micropores have been impregnated, as defined below, or completely filled with the selective polymer material.

The membranes may also include backing layers comparable to those used for conventional gas separation membranes, so long as those backing layers are not microporous.

Under the same conditions, a gas separation membrane of a given effective thickness (as defined in the detailed description below), in which all internal resistance caused by stagnant gas has been eliminated, will manifest a permeance for water vapor that is the same as that of a dense film of the same thickness made from the pure polymer of the selective layer.

This relationship can be used to define a quantitative measure of the extent to which the internal resistance has been eliminated, as discussed in more detail below.

The membranes may take the form of flat sheets or hollow fibers, both of which forms are familiar to those of skill in the art.

In a basic preferred embodiment, the membrane of the invention comprises:
(i) a support zone comprising a microporous region containing a multiplicity of micropores;
(ii) a selective zone comprising a selective polymer that is selective in favor of water vapor over the second gas, the selective zone being impregnated into the micropores in such a manner that at least a fraction of the microporous region is filled by the selective polymer;
   the membrane having a physical integrity that is maintained after the membrane has been exposed to air at less than 2% RH for at least 24 hours.

Preferably, the fraction of the microporous region filled by the selective polymer is at least about 30 vol %.

It is also preferred that the selective zone be predominantly impregnated into the pores, rather than predominantly in the form of a surface coating, with comparatively little pore filling. In other words, more than 50% of the selective zone overall average thickness should be within the pores.

As a second consequence of our discovery, meeting the above requirements to diminish unwanted resistance to permeation within the membrane structure is more important than the choice of polymer for the selective zone or layer. Materials of the highest permeability or hydrophilicity are no longer required; by recognizing and addressing the internal resistance problem, membranes with good performance and that are easy to prepare, inexpensive and mechanically robust can be made from a range of materials. Expensive and brittle materials, such as ion-exchange materials, can now be avoided and replaced by cheaper, better materials.

In a particularly preferred embodiment, the membrane of the invention uses a polyether or a polyamide-polyether block copolymer as the selective polymer. This copolymer includes glassy polyamide blocks, that improve the mechanical strength of the membrane, and rubbery polyether blocks, that provide good water permeability.

For use, it is convenient to house the membranes in one of the conventional forms of membrane modules, such as potted hollow fiber modules, spiral-wound modules or plate-and-frame modules, all of which forms are familiar to those of skill in the art.

In its simplest basic form, a membrane module comprises:
(i) a membrane having a feed side and a permeate side;
(ii) a housing in which the membrane is contained;
(iii) a feed inlet through which a feed gas mixture can be introduced into the housing and brought into contact with the feed side of the membrane;
(iv) a residue outlet through which gas that has passed along the feed side of the membrane without permeating can be withdrawn from the housing, and
(v) a permeate outlet through which gas that has permeated the membrane can be withdrawn from the housing.

A preferred form of module is a spiral-wound module.

If the module is to be used to carry out gas separation using a sweep gas on the permeate side, then the module should also include an inlet to the permeate side of the membranes by which the sweep gas can be passed into the module.

In another aspect, the invention is a process for managing the humidity of an environment. In this aspect, a basic embodiment of the invention comprises the following steps:
(a) providing a membrane module, comprising:
(i) a membrane having a feed side and a permeate side, the membrane comprising:
(A) a support zone comprising a microporous region containing a multiplicity of micropores;
(B) a selective zone comprising a selective polymer that is selective in favor of water vapor over the second gas, the selective zone having an average thickness and being at least partially impregnated into the micropores, such that at least 50 vol % of the average thickness is within the microporous region;
(ii) a housing in which the membrane is contained;
(iii) a feed inlet for introducing a feed gas mixture into the housing;
(iv) a permeate outlet for withdrawing a permeate gas stream from the housing; and
(v) a residue outlet for withdrawing a residue gas stream from the housing.
(b) introducing the feed gas mixture into the housing through the feed inlet and allowing it to flow across the feed side under a set of process operating conditions that provide a transmembrane flow of water vapor from the feed side to the permeate side; thereby forming the residue gas stream and the permeate gas stream;
(c) withdrawing the residue gas stream from the residue outlet;
(d) withdrawing the permeate gas stream from the permeate outlet;
(e) passing at least one of the residue gas stream and the permeate gas stream to the environment; the process being further characterized by a water-vapor permeance of at least about 3,000 gpu.

Preferably, the fraction of the microporous region filled by the selective polymer is at least 30 vol %.

The process may be pressure driven or concentration driven.

In either case, it is preferred that the process provides a water vapor permeance across the membrane of at least about 3,000 gpu, and more preferably at least about 4,000 gpu and most preferably at least about 5,000 gpu. Using the membranes of the invention, it is possible to achieve such water permeances under technically and economically reasonable operating conditions.

The humid feed gas stream from which the water vapor is extracted by the membrane may be from any source. As a non-limiting example, the feed gas stream is air.

The process produces two gas streams, a residue stream of lower water content than the feed gas stream and a permeate stream of higher water content than the feed gas stream. One of these is passed into the environment that it is desired to control. If the goal of the process is to increase the humidity of the environment, the permeate stream is passed to the environment; if the goal is to decrease the humidity, the residue stream is passed to the environment.

Non-limiting examples of environments where controlled humidity is important and to which the residue or permeate streams are sent include those mentioned in the background section above, such as storage facilities, manufacturing areas, reaction vessels, electrochemical cells, and spaces occupied by humans.

In some cases, the humid feed gas stream may be a stream withdrawn from the environment, such as a waste or vent gas from a process. The environment and the membrane system then form an integrated system. The humidification processes taught in U.S. Pat. No. 6,106,964, to Voss et al. and U.S. Pat. No. 6,145,588, to Martin et al. are specific examples of such schemes.

It is to be understood that the above summary and the following detailed description are intended to explain and illustrate the invention without restricting its scope.

### BRIEF DESCRIPTION OF THE DRAWINGS

FIG. 1a is a schematic representation of a single layer membrane of the invention in which the selective zone is fully impregnated into a porous support zone, and essentially fills the pores of the support zone, and no backing layer is used.

FIG. 1b is a schematic representation of an alternative single layer membrane of the invention in which the selective zone is fully impregnated into the support zone, and partially fills the pores of the support zone.

FIG. 2 is a schematic representation of multi-layer membrane in which the selective zone both impregnates and partially coats the support zone.

FIG. 3 is a schematic representation of a single layer membrane of the invention in which the selective zone is held within a macroporous support zone.

FIG. 4 is a schematic representation of a multi-layer membrane of the invention in which the support zone is a discrete macroporous layer supported by the support zone.

FIG. 5 is a schematic representation of a multi-layer membrane of the invention that includes a backing layer.

FIG. 6 is a schematic drawing of a basic embodiment of the process of the invention.

FIG. 7 is a is a schematic drawing of an embodiment of the process of the invention in which the feed gas stream comes from the environment and the residue gas stream is returned to the environment.

FIG. 8 is a schematic drawing of an embodiment of the process of the invention in which a transmembrane driving force is provided by sweeping the permeate side of the membrane.

FIG. 9 is a schematic drawing of an embodiment of the process of the invention in which the feed gas stream comes from the environment and is used to humidify a dry gas stream that is passed into the environment.

### DETAILED DESCRIPTION OF THE INVENTION

As used herein, permeability is a polymer property and measures the rate of volume flow of gas through unit area of a film of that polymer of unit thickness under unit driving force. The permeability unit is the Barrer, where 1 Barrer is 1×10⁻¹⁰ cm³(STP)/cm²·s·cmHg.

As used herein, flux is the flow rate of gas through a membrane. Units of flux are typically cm³/s.

As used herein, permeance, or pressure-normalized flux, is the flow rate of gas through unit area of a membrane under unit driving force, and is usually expressed in gpu, where 1 gpu is 1×10⁻⁶ cm³(STP)/cm²·s·cmHg.

As used herein, a set of process operating conditions means the feed gas composition and flow rate, the pressures and temperatures of the feed, residue and permeate gas streams, and the composition, pressure, temperature and flow rate of the sweep stream, if a sweep stream is used.

As used herein, dense as referred to a polymer film or membrane layer means substantially non-porous, that is, non-porous enough that gas transport occurs by solution-diffusion and gas permeation properties are consistent therewith.

As used herein, zone refers to a region within a membrane, including a continuous layer, a discontinuous layer and an area of polymer within the membrane structure.

As used herein, microporous means having pores with an average pore diameter in the range 0.01-0.5 μm.

As used herein, macroporous means having pores with an average pore diameter greater than about 0.5 μm.

Percentages are by volume herein, unless stated otherwise.

As used herein, essentially or substantially free of micropores means that the total volume of any zone within the membrane is less than 10% occupied by open micropores.

As used herein, heavily impregnated refers to any microporous support zone within a membrane that is at least 30% filled by the selective polymer zone.

As used herein, glassy polymer means a polymer that is below its glass transition temperature under the conditions at which it is used, and rubbery polymer means a polymer that is above its glass transition temperature under the conditions at which it is used.

The invention is a membrane, membrane module and membrane process for controlling humidity in an environment.

The membrane includes a porous support polymer zone and a dense selective polymer zone, and differs from membranes currently used for gas separation in that the porous support zone is impregnated by the dense selective zone, and more preferably the porous support zone is heavily impregnated, and most preferably for some applications is essentially devoid of unfilled microporous regions through its total thickness.

Such a membrane could be made by simply forming a thick, dense film of a selective polymer. A membrane of this type is not within the scope of the invention, however, as it lacks the support zone necessary to provide mechanical strength.

Various membrane configurations without microporous zones are possible within the scope of the invention. These configurations fall into two categories: those in which no microporous zones are used in any layer, and those in which a layer or zone with a microporous structure is used, but wherein the micropores have been either impregnated or completely filled with the selective polymer material.

We prefer the latter category for at least applications where mechanical strength is very important, as we believe more robust and stable membranes result from this configuration.

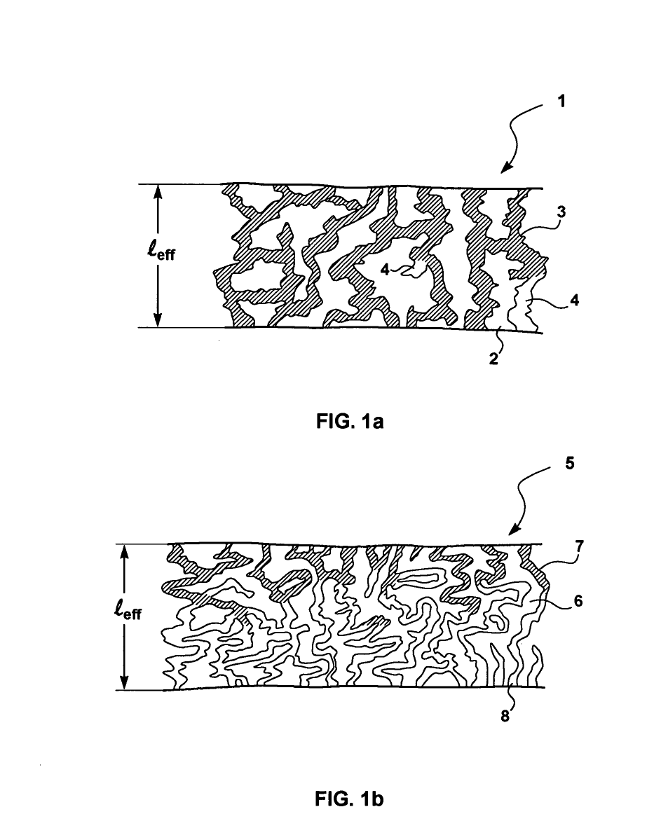

Some representative membrane configurations are shown in FIGS. 1-5.

FIG. 1a shows a single layer membrane, generally indicated by numeral 1. The membrane includes a support polymer matrix zone, 2, and a zone or zones filled with the selective polymer, 3. The support zone can be a porous or microporous polymeric layer.

The pores of the support matrix or zone, 2, are impregnated with the selective polymer to form filled zones, 3. Ideally in this embodiment, the selective polymer should completely fill every pore, so that no unfilled area is left in which gas can become stagnant.

In practice, it is difficult to ensure that every micropore is completely filled, and the membrane may contain small areas, 4, that remain unfilled. These areas should preferably constitute no more than a few percent of the total fillable pore volume, such as 10% and more preferably 5%. In other words, at least 90 vol % of the microporous region should be filled by the selective polymer.

FIG. 1b shows a different embodiment, with another single layer membrane, generally indicated by numeral 5. The membrane includes a support polymer matrix zone, 6, a zone or zones filled with the selective polymer, 7, and an unfilled porous region, 8. In this case, the filled region represents a fraction of the total pore space of the support zone.

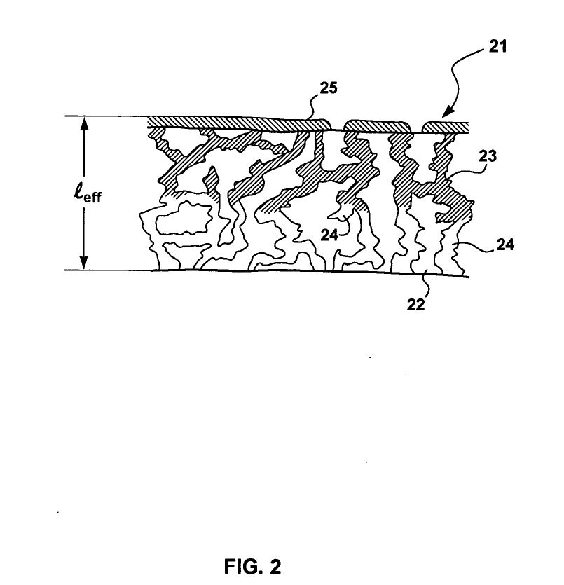

FIG. 2 shows a membrane, 21, similar to that of FIG. 1, but in which a thin continuous or discontinuous coating of selective polymer, 25, remains on the surface of the porous support matrix, 22. This selective polymer can be the same or different from the selective material, 23, that fills the support matrix. As in FIG. 1a, the micropores of the support membrane may be essentially completely filled by the selective polymer, leaving only small unfilled areas, 24, or the membrane may be similar to that of FIG. 1b, with at least a fraction of the micropores filled by the selective material.

In this embodiment, the total average thickness of the selective layer includes the impregnated and coating portions. The thickness of the coating portion should be much less than the thickness of the impregnated portion.

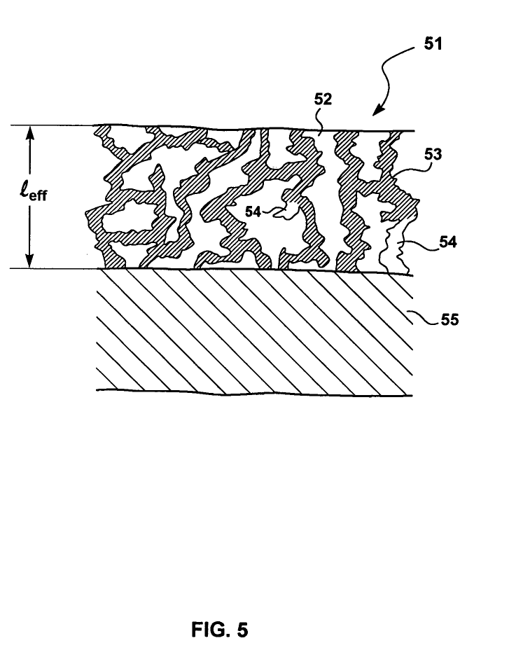

FIG. 5 shows a membrane, 51, similar to that of FIG. 1, but in which an openly macroporous backing web, 55, underlies the support matrix, 52, and provides additional mechanical support for the membrane. The support matrix is again filled with selective polymer zones, 53; a few unfilled areas, 54, remain. Variants of FIG. 5 in which only a portion of the pores are filled, as in FIG. 1b, are also possible.

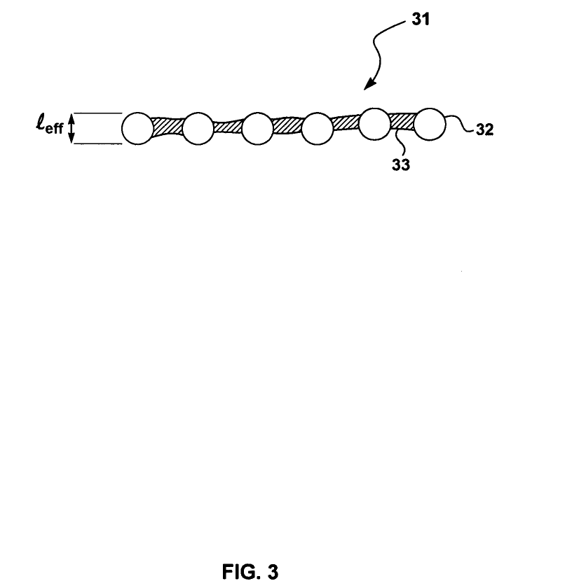

For the membranes of the invention, the support may be macroporous throughout, as in FIG. 3, microporous throughout, as in FIGS. 1 and 2, or may be of a varying or graded porosity, as in FIG. 5. The support should not have a dense skin layer, as is commonly found in supports for gas separation membranes. General preparation techniques for making all of these types of membranes are known in the art. Representative methods for making isotropic porous membranes include thermal gelation, track etching and stretching a polymer film. Such membranes may also be purchased from commercial suppliers. For example, Nuclepore® polycarbonate track-etched membranes may be purchased from Whatman, Inc., Celgard® stretched polyolefin membranes may be purchased from Celgard LLC, and Solupor® microporous fibrillated polyethylene may be purchased from DSM Solutech.

Anisotropic membranes are usually made by solvent casting. The support membrane may be cast on a casting plate or web from which it is removed after manufacture. Alternatively, the support membrane may be cast on a backing web that remains in place as a discrete membrane layer, as shown in FIG. 5.

All of these techniques are well established in the membrane industry and are described in, for example, R. W. Baker Membrane Technology and Applications, Second Edition, Wiley, 2003.

The polymer used for the support zone or layer should remain mechanically strong under the operating conditions of the process, and should obviously be amenable to the membrane making techniques described above. Suitable polymers for this function include, but are not limited to, polysulfone, polyimide, polyvinylidene fluoride, polyamide, polyethylene, polypropylene and polytetrafluoroethylene. Polymers that become significantly water-swollen in conditions of high humidity should be avoided for the reasons described below.

The polymer used for the selective zone should have a high permeability for water vapor, and should exhibit selectivity for water vapor over other gases from which the water vapor is to be removed.

As mentioned in the background section above, many polymers, both hydrophilic and hydrophobic, are very permeable to water vapor, and a potentially large pool of candidate polymers is available. However, other criteria than permeability should also be considered in choosing a polymer for the selective layer.

In humidity control applications, there are likely to be times when the membrane is not in active use, and may be exposed to relatively dry gas on both sides of the membrane. When swollen in the presence of water, many hydrophilic polymers form hydrogels, which are relatively soft and flexible, and have good water transport properties. If the polymer is inherently a stiff, glassy material, however, it becomes brittle and liable to crack or crumble as it dries out. Ion-exchange polymers, for example, suffer from this problem, which is one of the problems solved by our invention. Thus, they should not be used in our invention.

A significant criterion for our membranes, therefore, is that the polymer should maintain its physical integrity over a wide range of conditions, preferably from 0-100% RH. We consider that a membrane maintains its physical integrity if it can pass both a visual inspection test and a gas permeation test after a drying test in which the membrane is exposed to air at less than 2% RH for at least 24 hours.

Specifically, the membrane should have no new cracks or blemishes after being subjected to the drying test, and, on being tested for gas permeation properties, should provide a water vapor permeance and water vapor/nitrogen selectivity that are both within 20% of the water vapor permeance and water vapor/nitrogen selectivity measured under like conditions before the test.

Preferably, the membrane should also maintain its physical integrity (as measured by visual inspection and gas permeation testing) after a humidity cycling test of at least 10 cycles of exposure to gas saturated with water vapor followed by exposure to dry gas.

For the reasons above, the polymer used for the selective zone should not be an ion-exchange material or other very rigid and glassy material. In general, it is preferred that the selective polymer and the membrane as a whole be uncharged, by which we mean charge neutral.

It is also preferred that the selective material polymer be easy and inexpensive to prepare. Polymers that need to be chemically modified after the polymer has been formed, for example by adding side groups or chains, should be avoided if possible.

For the same reason, complicated manufacturing techniques should be avoided. For example, membranes with extremely thin selective layers can be made by interfacial polymerization. In this method, a solution of a reactive prepolymer is deposited in the pores of a support membrane. The loaded support is immersed in a solution of a second reagent, the second solution being immiscible with the first. The reagents react at the interface of the solutions to form a densely crosslinked, extremely thin membrane layer.

This method is not suitable for our invention, because the thin crosslinked region is underlain by a less crosslinked hydrogel that fills the pores of the support membrane. The properties of this hydrogel cannot readily be controlled and if the gel was allowed to dry out, could lead to the kind of membrane integrity failure discussed above.

In general, it is preferred that the polymer used for the selective zone should be rubbery, or if a copolymer is used, should contain a rubbery segment or repeat unit. Preferred copolymers are those, such as block copolymers, having a rubbery repeat unit and a glassy repeat unit.

Representative highly preferred materials from which the selective zones of the membrane can be made include, but are not limited to, polyethers; copolymers of polyethers with polyamides, polyimides or other rigid polymers; polyurethane polymers; and copolymers including a polyurethane segment. Less preferred polymers that could be used include polyvinyl-alcohol, polyvinyl acetate, polyvinyl pyrrolidone, polyethylene oxide and polyacrylamide and chitosan.

Membranes of the type shown in FIGS. 1, 2 and 5 have all or just a fraction of the pores filled, and may optionally include material coating the microporous layer, as in FIG. 2. Although the degree of filling may vary, it is preferred that the selective zone be predominantly impregnated into the pores, rather than predominantly in the form of a surface coating with comparatively little pore filling. In other words, more than 50% of the selective zone overall average thickness, preferably at least 80%, and most preferably at least 90% of the overall average thickness, should be within the pores.

Membranes of these types may be made by immersing the support membrane in a solution containing the selective polymer, withdrawing and drying the support. A convenient method is the dip-coating method. This method is familiar to those of skill in the art as a method used to make composite gas separation membranes by depositing a very thin selective polymer layer on the dense, skin side of an asymmetric support membrane.

In the present invention, the selective polymer solution is deposited onto a microporous support without a dense skin, and instead of remaining on the surface of the support can penetrate the pores. To achieve good filling of the pores to the desired extent, the coating solution should be very dilute, typically no more than about 1% polymer, and the molecular weight of the polymer should be relatively low, preferably less than 50,000, and more preferably less than 20,000.

Even more preferably, the selective polymer solution should contain a polymer or prepolymer of molecular weight less than 10,000 and most preferably less than 5,000, and a crosslinking agent should be added to the solution. Solutions containing a low concentration of a low molecular weight polymer or prepolymer have low viscosity and the polymer segments are small, both of which facilitate good penetration of solution into the microporous regions of the support membrane. Such solutions are most preferred for making the membrane.

The solution may be deposited in the pores by immersion, dip-coating or the like and the filled support directed to an oven where the support is dried at an elevated temperature to crosslink the polymer.

We have found that membranes made with low molecular weight selective materials that are subsequently crosslinked within the pores of the support membrane exhibit improved mechanical properties and greater durability than uncrosslinked membranes. For example, we have found that polyether membranes made in this way may be boiled in water for a week, and still maintain good properties.

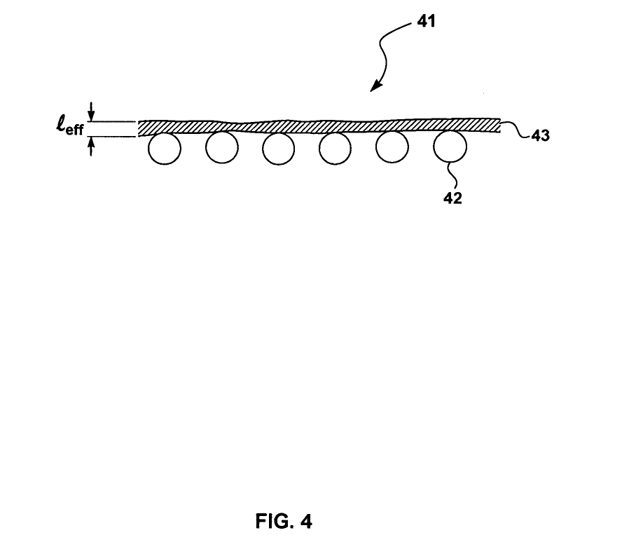

FIGS. 3 and 4 show less preferred, alternative embodiments of the membrane of the invention, in which no microporous zones are used in any layer.

FIG. 3 shows a membrane, 31, having selective zones, 33, held in a support, 32. In this case the support takes the form of a relatively open woven or non-woven fibrous sheet, with the selective zones filling the interstices between the fibers. Such a membrane may be made by the same types of immersion or coating techniques discussed above.

FIG. 4 shows yet another alternative arrangement, in which the fibrous sheet supports the overlying selective layer. Such membranes may be made by casting a thin film of the selective polymer on water or glass, for example, then picking up the film on a macroporous support.

To achieve high water vapor flux, the membranes of the invention should be thin, by which we mean they should have an effective thickness less than 100 μm, more preferably no more than about 50 μm and most preferably in the range 20-40 μm.

By effective thickness, we mean the thickness of the layer or layers that incorporate the selective zone or zones. Thus, in FIGS. 1, 2, 3 and 5, the effective thickness includes the total thickness of the support zone. In FIG. 4, the effective thickness is the thickness of the selective layer only. The effective thickness is identified in FIGS. 1-5 as l_{eff}.

One of the goals of the invention is to provide membranes with high water vapor permeances that reflect, or take better advantage of, the high permeability of the selective polymer. A quantitative measure of the extent to which internal resistance has been eliminated is to compare the permeance of the membrane measured under a set of operating conditions with the permeance under the same conditions of a dense film of the same thickness as the effective thickness, and made from the pure polymer of the selective layer.

If the membrane has no open microporous areas, the permeance of the membrane will be as high as the permeance of the film. As we believe that difference in performance under identical operating conditions is attributable to microporosity remaining in the membrane, we consider the membrane to meet the objective of having essentially eliminated open microporous areas if the permeance of the membrane measured as defined is within 90% of the permeance of the dense film measure under the same test conditions.

A second, more qualitative, but reliable indicator that the micropores are essentially filled is the membrane appearance. A membrane in which a region or regions of unfilled pores remain will appear milkily translucent or opaque in that region, because light can be scattered or absorbed at the air/polymer interface. A membrane in which the pores are filled or essentially filled by polymer will appear transparent over substantially all of its surface, because no air/polymer surfaces for light scattering remain within the membrane.

For some uses, membrane performance is sufficiently improved over prior art membranes even if the microporous regions of the membrane are only partially filled by the selective zone, as described above and shown in FIG. 1b. In this case, it is preferred that the fraction of filled pores is such that at least 30 vol % of the microporous region is filled by the selective polymer. For some applications, a lesser degree of filling can be suitable.

If the microporous regions are only partially filled, the criteria discussed above are unreliable, because the average thickness of the selective zone may be considerably less than the thickness of the support zone, because it is not possible to measure this thickness accurately, and because the membrane may appear translucent or partially opaque rather than transparent.

An alternative quantitative measure of the membrane performance applicable to all membranes within the scope of the invention is that they provide a water vapor permeance, when mounted in a spiral-wound module and subjected to a gas permeation test using air at 100% RH as a test feed gas and air at less than 50% RH as a sweep gas, of at least about 3,000 gpu.

Under many operating conditions, therefore, the membranes will enable the process to manifest a water vapor permeance of at least about 3,000 gpu, and more preferably at least about 5,000 gpu. These permeances are much higher than has been achieved by prior art membranes for membrane-based gas separation, where permeances below 1,000 gpu are normal.

If the membrane has been made by following the teachings above, it should exhibit adequate physical robustness to be handled and housed in membrane modules, and to withstand subsequent process operating conditions. In addition to meeting a humidity cycling test as already described, the finished membranes should be able to be repeatedly thermally cycled between 0° C. and 100° C. without loss of physical integrity.

They should also be able to withstand at least 10 cycles of a flex durability test such as ASTM F392-93(2004) (Standard Test Method for Flex Durability of Flexible Barrier Materials). Without the formation of pinholes or cracks.

For use, the membranes may be housed in any convenient type of membrane module, such as potted hollow fiber, spiral-wound or plate-and-frame. The making of all of these types of module is well documented and familiar to those of skill in the art.

We prefer to house the membranes in spiral-wound modules. In brief, a spiral-wound module consists of one or more membrane envelopes wound around a perforated central collection tube and contained in a tubular housing. When the module is wound, spacers are included on the inside and outside of the membrane envelopes to hold open feed and permeate channels for gas flow. The spacers are typically, but not necessarily, made from plastic mesh or netting, which helps to promote turbulent flow in the gas channels.

In manufacturing spiral-wound modules, care is taken in the choice of spacers. An overly tight mesh may result in pressure drops along the feed or permeate channel that adversely affect separation performance when the module is in use. Likewise, a tight spacer may facilitate the formation of the stagnant boundary layers described above that give rise to concentration polarization adjacent to the membrane surface.

Similar issues affect the manufacture of plate-and frame-modules. Hollow fiber modules do not normally require spacers, because the fibers are held in spaced-apart relationship by the potting compound. Nevertheless, the packing density may promote concentration polarization in some separations.

These issues have previously been recognized in the art and the use of particular spacer types and configurations to address them is discussed in various patents and technical literature (see, for example U.S. Pat. No. 4,861,487, to Fulk; U.S. Pat. No. 5,069,793, to Kaschemekat; U.S. Pat. No. 5,275,726, to Feimar; and U.S. Pat. No. 6,881,336, to Johnson, all of which are incorporated herein by reference).

In making the water vapor separation module or device, the practices already taught in the art should be followed with respect to the spacers that are used. For example, if the module is a spiral-wound module incorporating mesh spacers, the spacers should preferably be, as in any module intended for gas separation use, sufficiently strong to support the membrane and hold open the feed and permeate channels, and sufficiently open to limit pressure drops along the channels and concentration polarization problems.

More details on the manufacture of spiral-wound modules can be found in U.S. Pat. No. 3,417,870, to Bray; U.S. Pat. No. 4,746,430, to Cooley; and U.S. Pat. No. 5,096,584, to Reddy et al.

If the module is to be used to carry out gas separation using a sweep gas on the permeate side, then the module should also include an inlet to the permeate side of the membranes by which the sweep gas can be passed into the module. Spiral-wound modules of this type are taught in U.S. Pat. No. 5,034,126, to Reddy et al., for example.

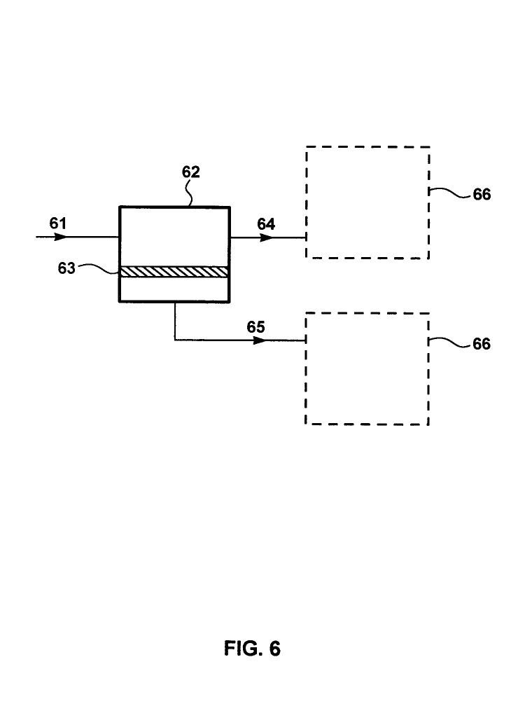

In another aspect, the invention is a process for managing the humidity of an environment. The process in a basic aspect is shown in FIG. 6. Referring to this figure, a feed gas stream, 61, containing water vapor, is introduced on the feed side into a membrane separation unit, 62, containing membrane, 63. The feed stream flows across the feed side of the membrane and is separated into a residue stream, 64, of lower water content than the feed stream and a permeate stream, 65, of higher water content than the feed stream. The residue or permeate stream is passed to the environment, indicated by dashed box, 66, in which humidity control is desired.

The feed gas stream may be made up of any gas or gas mixture from which it is desired to remove water vapor. Representative non-limiting gases and gas mixtures include nitrogen, oxygen, carbon dioxide, air, methane and other light hydrocarbon gases, natural gas, and noble gases.

The membrane includes a porous support zone and a selective zone at least partially impregnated into the pores of the support zone, as described above, and preferably has an effective thickness no more than about 50 μm and most preferably in the range 20-40 μm.

The membrane separation unit includes at least one membrane module, and may include multiple membrane modules arranged in series or parallel to form a membrane array, as in known in the art.

To create the residue and permeate streams, a driving force for transmembrane permeate is provided by a concentration difference, a pressure difference or both across the membrane. If the driving force for water vapor permeation across the membrane is a pressure difference between the feed and permeate sides, this can be generated in a variety of ways. The pressure difference may be provided by compressing the feedstream, drawing a vacuum on the permeate side, or a combination of both. Such operations are commonplace and familiar to those of skill in the art. In general, compressing the feed to high pressure, although not absolutely excluded from the scope of the process, will not be practical except in a few cases where other operating conditions are unusual, because compression will tend to condense liquid water out of the feed stream.

If water vapor permeation across the membrane is concentration driven, a concentration difference may conveniently be provided by sweeping the permeate side with a stream of gas that is dry relative to the feed gas. This gas may be the same as the feed gas or different from the feed gas. For example, if the feed gas is air, the sweep gas may also be air; but could be nitrogen, some other inert gas, or a reagent gas, for example.

Concentration polarization effects on the feed and permeate sides of the membrane are difficult to avoid for the difficult separation of water vapor from a gas mixture. Nevertheless, by using standard practices known in the art, such as selecting feed and permeate spacers appropriately and selecting a module geometry to encourage rapid and turbulent fluid flow adjacent to the membrane surfaces, concentration polarization outside the membrane may be limited.

If this is done in conjunction with the innovations taught herein with respect to membrane structure and manufacture, it is possible to provide a water-vapor permeance under the process operating conditions of at least about 3,000 gpu, more preferably at least about 5,000 gpu or even higher. Such high water vapor permeances in gas separation processes have been unknown previously in humidity control applications.

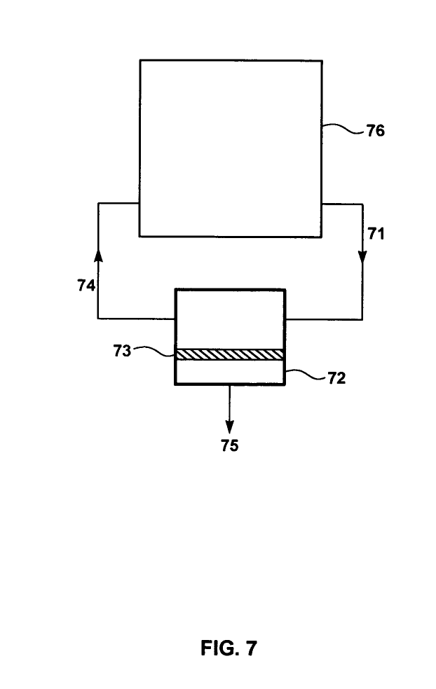

An embodiment of the process of the invention in which the feed gas stream comes from the environment and the residue gas stream is returned to the environment is shown in FIG. 7. In this figure, options and preferences are the same as for FIG. 6 unless specified otherwise.

Referring to FIG. 7, a feed gas stream, 71, containing water vapor, is withdrawn from the environment, 76, and introduced on the feed side into a membrane separation unit, 72, containing membrane, 73. The feed stream flows across the feed side of the membrane and is separated into a residue stream, 74, of lower water content than the feed stream and a permeate stream, 75, of higher water content than the feed stream. The relatively dehydrated residue stream is returned to the environment; the water-rich stream, 75 is withdrawn from the process.

Such a process can be used, for example, as part of a commercial drying operation to dry wet solids, such as in the food, chemical, agricultural, textile or paper industries, or for humidity control in an air-conditioner.

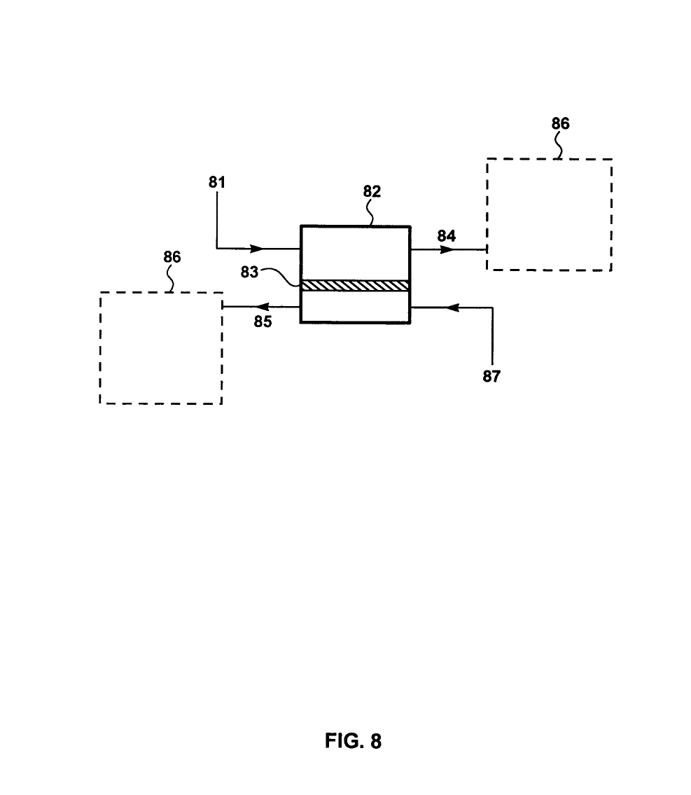

FIG. 8 shows an embodiment of the process in which the driving force for transmembrane permeation is provided by a sweep gas flowing across the permeate side of the membrane, preferably, but not necessarily, in a direction countercurrent to the flow of feed gas. As before, options and preferences are the same as for FIG. 6 unless specified otherwise.

Referring to FIG. 8, a feed gas stream, 81, containing water vapor, is introduced on the feed side into a membrane separation unit, 82, containing membrane, 83. The feed stream flows across the feed side of the membrane and is separated into a residue stream, 84, of lower water content than the feed stream. A sweep stream, 87, is introduced on the permeate side of the membrane and flows across the permeate side. Permeate stream, 85 is withdrawn from the permeate side. Either stream 84 or stream 85, depending on whether a dry or a humid stream is required, is passed to the environment, 86.

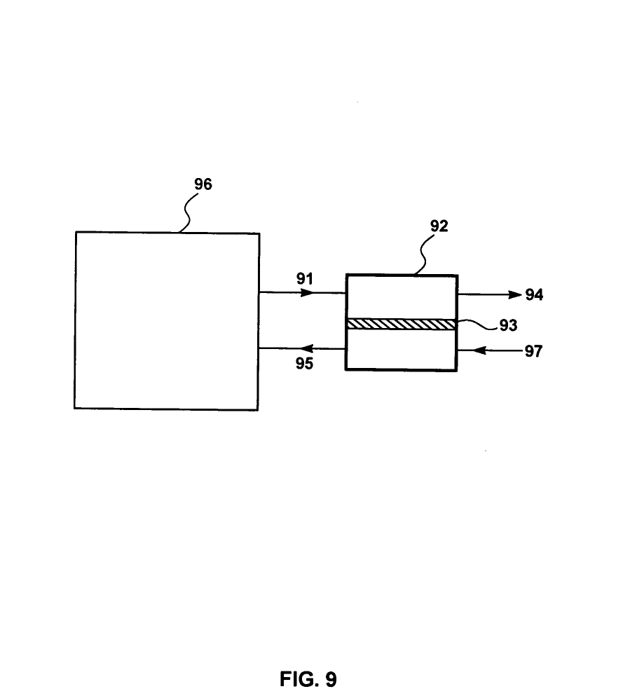

FIG. 9 shows an embodiment of the process in which a sweep gas is used on the permeate side to capture water for return to an environment. As before, options and preferences are the same as for FIG. 6 unless specified otherwise.

Referring to FIG. 9, feed gas stream, 91, containing water vapor, is withdrawn from environment, 96, and introduced on the feed side into a membrane separation unit, 92, containing membrane, 93. The feed stream flows across the feed side of the membrane and is separated into a residue stream, 94, of lower water content than the feed stream, which is discharged from the process. A sweep stream, 97, is introduced on the permeate side of the membrane and flows across the permeate side. Humidified permeate stream, 95 is withdrawn from the permeate side and passed to the environment.

The invention is now illustrated in further detail by specific examples. These examples are intended to further clarify the invention, and are not intended to limit the scope in any way.

### EXAMPLES

### Example 1

### Preparation of Microporous Support Layer for Composite Membranes—not in Accordance with the Invention

A series of microporous support membranes was made according to standard casting techniques used to prepare composite gas-separation membranes. A casting solution of polyetherimide (PEI) in a water-miscible solvent was prepared and doctored onto a moving backing web of polyester. The web was passed into a water bath, where the polymer precipitated to form the film. The coated web was collected on a take-up roll, washed to remove any remaining solvent, and dried to form the support film.

The result was a series of two-layer structures, of total thickness in the range 120-150 μm. The microporous support layer had an asymmetric structure, graded to a very fine, almost dense skin layer.

### Example 2

### Preparation of a Typical Composite Gas Separation Membrane—not in Accordance with the Invention

A polydimethylsiloxane (PDMS) sealing/gutter layer was dip-coated onto a microporous support prepared as in Example 1. The PDMS layer was dip-coated with single pass through a solution of 2.5 wt % Pebax® 2533 (Atochem Inc., Glen Rock, N.J.) in ethanol, which formed the selective layer. The resulting membrane had four discrete layers: a backing layer, a microporous support layer, a gutter layer and a selective layer. The membrane was 150 μm thick overall and was designated as Sample 1.

### Example 3

### Preparation of a Three-Layer Composite Membrane—not in Accordance with the Invention

A microporous support of the type described in Example 1 was single-coated with a solution of 0.5 wt % Pebax® 1657 in butanol to form a selective layer. This membrane differed from Sample 1 in that no gutter layer was included and a more hydrophilic grade of Pebax was used. The resulting membrane was 125 μm thick and was designated as Sample 2.

### Example 4

### Preparation of a Membrane without Backing Layer—not in Accordance with the Invention

A membrane of the type described in Example 3 was made. After the membrane had been dried, the polyester backing layer was hand peeled from the membrane. The resulting backless membrane was 75 μm thick and consisted of just a Pebax-coated PEI layer. This membrane was designated as Sample 3.

### Example 5

### Preparation of an Impregnated Membrane in Accordance with the Invention

A set of membranes was made using Solupor®, a microporous polyethylene film commercially available from DSM Solutech, Heerlen, The Netherlands. The Solupor films were placed on a commercial dip-coating machine and passed through a solution of polymer dissolved in solvent. After coating, the nascent membrane was passed into the drying oven, where the solvent evaporated, leaving the polymer in the pores of the film.

This coating process was used to make several membranes with different grades of Pebax®. The solution concentration for the polymers varied from 0.5 to 1 wt % and the number of coats varied from 1-3.

### Example 6

### Water Vapor Transport Experiments

An epoxy was used to attach membrane samples to the top of water-filled containers. The attached membrane formed a tight seal so that a barrier was created between the water in the container and the atmosphere outside the container.

The container was placed on a scale inside a forced hot air convection oven heated to 80° C. and weighed periodically to monitor changes in mass. Water vapor permeance for the samples was calculated using the membrane area and the mass of water lost from the container over time.

The experiments were carried out first using films of Nafion®, a highly water-permeable perfluorinated ion-exchange polymer (E.I. Du Pont de Nemours, 1007 Market St. Wilmington, Del. 19898), to determine baselines.

The experiments were then repeated using the membranes of Examples 2-4. The results are shown in Table 1.

TABLE 1

| | | | N₂ | |
|---|---|---|---|---|
| Membrane | Thickness | WVTR* | Permeance | O₂ Permeance |
| Sample | (μm) | g/min m² | (gpu) | (gpu) |
| Nafion ® 112 | 50 | 18 | 0.005 | 0.02 |
| Nafion ® 111 | 25 | 20 | 0.01 | 0.04 |
| Sample 1 | 150 | 5.2 | 20 | 52 |
| (with backing and | | | | |
| gutter layer) | | | | |
| Sample 2 | 125 | 9.9 | 1.7 | 5.2 |
| (with backing and | | | | |
| selective layer) | | | | |
| Sample 3 | 75 | 21 | 1.7 | 5.3 |
| (without backing) | | | | |

*Water Vapor Transfer Rate

As can be seen from the results in Table 1, these simple cup tests can provide only limited water permeation data. The Nafion® 111 and Nafion® 112 samples differ only in thickness. The 111 sample has half the thickness of the 112 sample, so should have a water vapor transport rate double that of the 111 sample. Instead, the measured transport rate was only marginally higher.

We concluded that, as the membranes become more permeable, the principal resistance to water transport is the layer of air in the cup, so the transport rate measured at that point is that dominated by, or of, the air layer, which appears to be about 20 g/min m².

Sample 1, which has both a backing layer and a relatively hydrophobic gutter layer, showed the worst water vapor transport. If this membrane had been manifesting the true water transport properties of the Pebax® layer, we would expect the transport rate to be at least about 100 g/min m², in other words at least an order of magnitude higher than was actually measured.

Likewise, even though Sample 2 was both thinner and much more hydrophilic overall than Sample 1, the water vapor transport properties were very poor—at least an order of magnitude too low—compared with the intrinsic capability of the Pebax layer.

Sample 3, the sample from which the backing had been removed to leave only two layers, showed improved water transport properties, but the transport at this point was limited by the air layer, so a measurement of the transport by the membrane itself was not possible.

The gas permeation data included show that the selective layer of the membrane was in fact a dense gas-tight layer of Pebax that exhibited the expected gas permeance and selectivity. These numbers remain the same for Sample 3 as for Sample 2, showing that the selective layer was not damaged by removing the backing. They also show that the Nafion® films have very low gas fluxes relative to the composite membranes.

### Example 7

### Water Vapor Transport with Impregnated Membranes

We attempted to measure the water vapor transfer rate of impregnated membranes prepared as in Example 5. The results showed water vapor transfer rates around the limits of 20. In other words, we were once again measuring the resistance of the air layer, not the membrane.

The results showed that the impregnated membranes have water vapor transport rates at least as good as the membranes from which the backing had been peeled. The results of Table 1 clearly indicate that resistance of other layers than the intended selective layer is a problem in humidity control applications, and that removing such extraneous resistances improves performance.

On this basis, the impregnated membrane have the least extraneous resistance and should demonstrate the best water transport properties.

I claim:

1. A gas-separation membrane adapted for removing water vapor from a gas stream comprising water vapor and a second gas, the membrane comprising:
(i) a support zone comprising a microporous region containing a multiplicity of micropores;
(ii) a selective zone comprising a selective polymer that is selective in favor of water vapor over the second gas, the selective zone being impregnated into the micropores in such a manner that at least 30 vol % of the microporous region is filled by the selective polymer;
the membrane having a physical integrity that is maintained after the membrane has been exposed to air at less than 2% RH for at least 24 hours.

2. The membrane of claim 1, wherein at least 90 vol % of the microporous region is filled by the selective polymer.

3. The membrane of claim 1, wherein the membrane is substantially transparent.

4. The membrane of claim 1, wherein the selective zone is impregnated into the micropores by dipping the membrane into a solution comprising the selective polymer, or a prepolymer for the selective polymer, and a crosslinking agent, withdrawing the membrane from the solution and drying the membrane at a condition that results in crosslinking of the selective polymer or prepolymer.

5. The membrane of claim 1, wherein the selective polymer comprises a rubbery repeat unit.

6. The membrane of claim 1, wherein the selective polymer comprises a copolymer having a rubbery repeat unit and a glassy repeat unit.

7. The membrane of claim 1, wherein the selective polymer comprises a polyether.

8. The membrane of claim 1, wherein the selective polymer comprises a polyamide-polyether block copolymer having the general formula 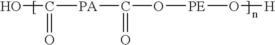
where PA is a polyamide segment, PE is a polyether segment and n is a positive integer.

9. The membrane of claim 1, wherein the membrane is uncharged.

10. The membrane of claim 1, wherein the membrane has an effective thickness less than 50 μm.

11. The membrane of claim 1, wherein the membrane has an effective thickness in the range 20-40 μm.

12. The membrane of claim 4, wherein the selective polymer or prepolymer has a molecular weight of less than 5,000 before crosslinking has taken place.

13. The membrane of claim 1, wherein the membrane consists essentially of the support zone and the selective zone.

14. The membrane of claim 1, characterized in that, when mounted in a spiral-wound module and subjected to a gas permeation test using air at 100% RH as a test feed gas and air at less than 50% RH as a sweep gas, the membrane can provide a water vapor permeance of at least about 3,000 gpu.

15. A spiral-wound membrane module adapted for removing water vapor from a gas stream comprising water vapor and a second gas, the membrane module comprising:
(a) a membrane having a feed side and a permeate side, the membrane the membrane comprising:
(i) a support zone comprising a microporous region containing a multiplicity of micropores;
(ii) a selective zone comprising a selective polymer that is selective in favor of water vapor over the second gas, the selective zone being impregnated into the micropores in such a manner that at least 30 vol % of the microporous region is filled by the selective polymer;
(b) a housing in which the membrane is contained;
(c) a feed inlet for introducing a feed gas mixture into the housing;
(d) a permeate outlet for withdrawing a permeate gas stream from the housing; and
(e) a residue outlet for withdrawing a residue gas stream from the housing.

16. The module of claim 15, further comprising a sweep inlet for introducing a sweep gas into the housing on the permeate side.

17. A process for controlling an environment at a desired humidity, comprising:
(a) providing a membrane module, comprising:
(i) a membrane having a feed side and a permeate side, the membrane comprising:
(A) a support zone comprising a microporous region containing a multiplicity of micropores;
(B) a selective zone comprising a selective polymer that is selective in favor of water vapor over the second gas, the selective zone having an average thickness and being at least partially impregnated into the micropores, such that at least 50 vol % of the average thickness is within the microporous region;
(ii) a housing in which the membrane is contained;
(iii) a feed inlet for introducing a feed gas mixture into the housing;
(iv) a permeate outlet for withdrawing a permeate gas stream from the housing; and
(v) a residue outlet for withdrawing a residue gas stream from the housing.
(b) introducing the feed gas mixture into the housing through the feed inlet and allowing it to flow across the feed side under a set of process operating conditions that provide a transmembrane flow of water vapor from the feed side to the permeate side; thereby forming the residue gas stream and the permeate gas stream;
(c) withdrawing the residue gas stream from the residue outlet;
(d) withdrawing the permeate gas stream from the permeate outlet;
(e) passing at least one of the residue gas stream and the permeate gas stream to the environment; the process being further characterized by a water-vapor permeance of at least about 3,000 gpu.

18. The process of claim 17, wherein the operating conditions comprise a difference in partial pressure of water vapor between the feed and permeate sides.

19. The process of claim 17, wherein the operating conditions comprise a difference in water vapor concentration between the feed and permeate sides.

20. The process of claim 17, wherein the membrane module further comprises a sweep inlet for introducing a sweep gas stream into the housing on the permeate side;
and wherein the process further comprises introducing the sweep gas into the housing and allowing it to flow across the permeate side, whereby the sweep gas stream sweeps the permeate side, and is mixed with the water vapor that has permeated the membrane to form the permeate gas stream.

21. The process of claim 17, wherein the feed gas mixture comprises a gas selected from the group consisting of nitrogen, oxygen, carbon dioxide, air, methane, natural gas and noble gases.

22. The process of claim 17, wherein the feed gas mixture comprises air.

23. The process of claim 20, wherein the sweep gas stream comprises air.

24. The process of claim 17, wherein at least 90 vol % of the average thickness is within the microporous region.

25. The process of claim 17, wherein the selective polymer comprises a polyether repeat unit.

26. The process of claim 17, wherein the membrane consists essentially of the support zone and the selective zone.

27. The process of claim 17, wherein the membrane module is a spiral-wound module.

28. The process of claim 17, wherein the environment is a storage facility.

29. The process of claim 17, wherein the environment is a manufacturing facility.

30. The process of claim 17, wherein the environment is a space occupiable by a human.

31. The process of claim 17, wherein the environment is a reactor interior.

32. The process of claim 17, wherein the environment is a fuel cell interior.

33. The process of claim 20, wherein at least one of the feed gas mixture and the sweep gas stream comes from the environment.

34. The process of claim 17, wherein the feed gas mixture comes from the environment and the residue gas stream is sent to the environment.

35. The process of claim 17, wherein the feed gas mixture comes from the environment and the permeate gas stream is sent to the environment.

36. The process of claim 17, wherein at least 30 vol % of the microporous region is filled by the selective polymer.
